(19) United States
(12) Patent Application Publication
(10) Pub. No.: US 2009/0240538 A1
(43) Pub. Date: Sep. 24, 2009

(54) System and Method for Local Call-Based Advertising

(75) Inventors: Jeffrey M. Sweeney, Olathe, KS (US); Kelsyn D.S. Rooks, SR., Overland Park, KS (US); Michael C. Robinson, Overland Park, KS (US); Robert J. Morrill, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/052,619

(22) Filed: Mar. 20, 2008

(51) Int. Cl. G06Q 30/00; H04M 15/00

(52) U.S. Cl. 705/7; 705/14

(57) ABSTRACT

A system and method for tracking calls based on advertising. An advertisement is communicated to a user through a communications network. A determination is made that a call connection is made between the user and one or more numbers associated with the advertiser. The advertiser is billed in response to the determined call connections.

### BACKGROUND

The use of and development of communications has grown nearly exponentially in recent years. The growth is fueled by larger networks with more reliable protocols and better communications hardware available to service providers and consumers. Despite the improvements in communications technology, advertisers have continued to utilize legacy systems and practices.

Existing advertisements mediums, such as television and radio advertising, are effective methods of advertising. However, determining the effectiveness and results of advertising may be difficult, costly, and speculative. Additionally, in most cases, advertisers use a broad approach to advertising. As a result, advertisers may be unable to determine the efficacy of the advertisements based on the associated expenditures.

### SUMMARY

One embodiment provides a system and method for tracking calls based on advertising. An advertisement may be communicated to a user through a communications network. A determination may be made that a call connection is made between the user and one or more numbers associated with the advertiser. The advertiser may be billed in response to the determined call connections.

Another embodiment includes a system for tracking calls generated based on advertisements. The system may include a communications network, one or more user connections and one or more advertiser connections communicating with the communications network. The system may also include a server connected to the communications network configured to track calls from the one or more user connections to the one or more advertiser connections. The server may include an advertiser interface configured to transmit advertisements to users through the one or more user connections. The server may also include a call tracking interface configured to identify calls from the one or more user connections to phone numbers dedicated for use with one of the advertisements. The interface may be operable to initiate billing of at least one advertiser based on a number of calls received by the advertiser through the phone numbers as a result of the one or more users calling the phone numbers.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a communications system in accordance with an illustrative embodiment;

FIG. 2 is a pictorial representation of a communications environment enabling advertising in accordance with an illustrative embodiment;

FIG. 3 is a pictorial representation of a telephone in accordance with an illustrative embodiment;

FIG. 4 is a block diagram of an advertising tracking system in accordance with an illustrative embodiment;

FIG. 5 is a flowchart of a process for tracking advertisements in accordance with an illustrative embodiment; and

FIG. 6 is a graphical user interface for tracking advertisements in accordance with an illustrative embodiment.

### DETAILED DESCRIPTION OF THE DRAWINGS

Illustrative embodiments provide a system and method for tracking advertising. In one embodiment, an advertisement may be received through a television, radio, phone or other similar advertising or communications medium. The user may elect at that time or later to receive additional information regarding the advertisement. The additional information may include phone numbers, coupons, directions, information, and details about the services or products advertised. Requests for additional information and calls between the user and numbers associated with an advertiser are tracked by a communications service provider. The concurrent or subsequent calls between the user and the advertiser are used to bill the advertiser for the advertising and gathering advertising statistics. The illustrative embodiments leverage the communications services offered by a local communications service provider to consumers through television, computer, wireless devices, radio, and telephones to better convey, track, and bill for advertising.

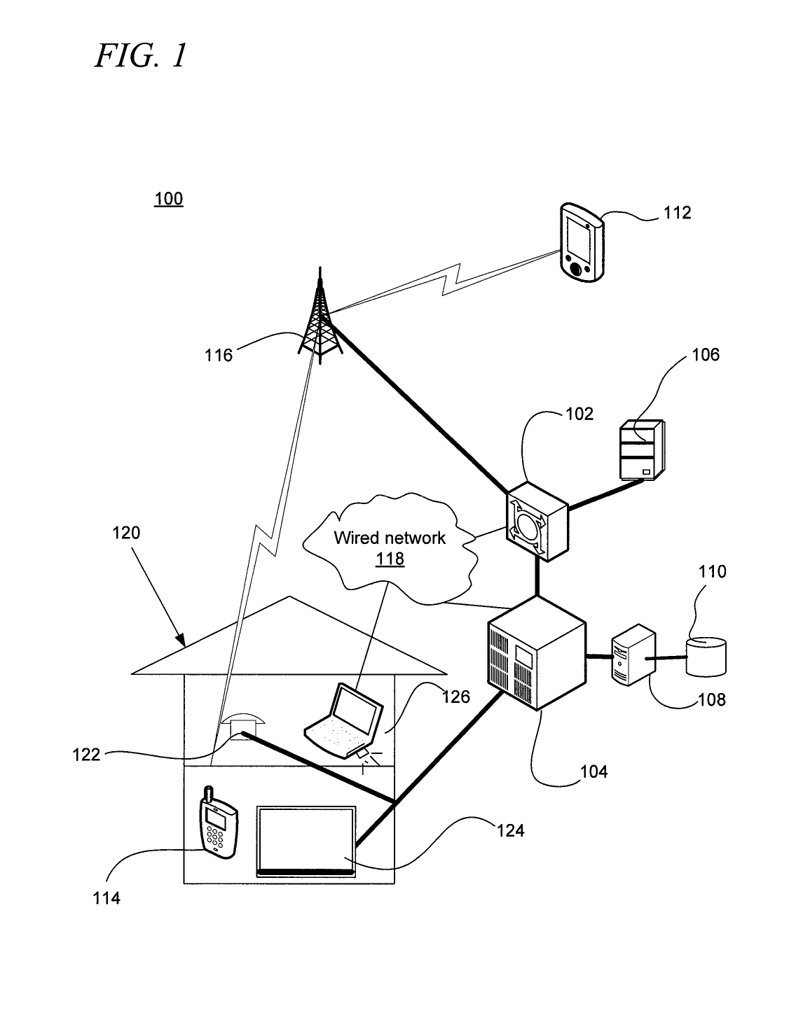

FIG. 1 is a pictorial representation of a communications system in accordance with an illustrative embodiment. The communication system 100 of FIG. 1 includes various elements used for wireless and wired communication. The communications system 100 includes a mobile switching center (MSC) 102, a local exchange 104, voicemail systems 106 and 108, a database 110, wireless devices 112 and 114, a transmission tower 116, a wired network 118, a home 120, home telephone 122, television 124, and a client 126. The different elements and components of the communications system 100 may communicate using wireless communications including satellite connections and/or hardwired connections, such as fiber optics, T1, cable, DSL, high speed trunks, and telephone lines.

The wireless devices 112 and 114 may communicate with the transmission tower 116 using communications protocols, such as time division multiple access (TDMA), code division multiple access (CDMA), global systems for mobile (GSM) communications, personal communications systems (PCS), WLAN, WiMAX, or other frequently used cellular and data communications protocols and standards. The wireless devices 112 and 114 may include cellular phones, Blackberry®, personal digital assistances (PDA), mp3 players, laptops, evolution data optimized (EDO) cards, multi-mode devices, and other wireless communication devices and elements.

Communications within the communications system 100 may occur on any number of networks which may include wireless networks, data or packet networks, cable networks, satellite networks, private networks, publicly switched telephone networks (PSTN), the wired network 118, or other types of communication networks. The networks of the communications system 100 may represent a single communication service provider or multiple communications services providers functioning independently or in combination. The features of the embodiments may be implemented by one or more elements of the communications system 100 independently or as a networked implementation.

In one embodiment, the MSC 102, voicemail system 106, and transmission tower 116 are part of a wireless network that is operated by a wireless service provider. For example, the control signals and operational features may be performed by the MSC 102 and the wireless signals may be broadcast from the transmission tower 116 to the wireless devices 112 and 114. The wireless network may include any number of systems, towers, servers, and other network and communications devices for implementing the features and performing the methods herein described. The wireless network may enable cellular, data, radio, television service, or other wireless protocols or communications. For example, the transmission tower 116 may transmit signals to cell phones, Blackberry devices, car radios, and high definition televisions.

The MSC 102 may be a switch used for wireless call control and processing. The MSC 102 may also serve as a point of access to the local exchange 104. The MSC 102 is a telephone exchange that provides circuit switched calling and mobility management and may also provide GSM or PCS services to the wireless devices 112 and 114 located within the area the MSC 102 serves. The MSC 102 may include a home location register (HLR) and visitor location register (VLR) that may be used to implement different features of the illustrative embodiments. The voicemail system 106 may be an integrated part of the MSC 102 or alternatively may be an externally connected device.

In one embodiment, the voicemail system 106 may include an integrated database for storing customer and usage information and data. The user may communicate, interact, or send and receive data, information, and commands to the voicemail system 106 through the telephone 122, television 124, wireless device 112 and 114, or the client 126. The MSC 102 and voicemail system 106 may include any number of hardware and software components.

In one embodiment, the MSC 106 is an advanced intelligence network device with software modules equipped to track calls from a user to any number of phone numbers, Internet Protocol (IP) addresses, or communications lines or elements associated with an advertiser. The calls may be tracked to determine the effectiveness of advertising communications provided to a user by the communications service provider on behalf of one or more advertisers.

The local exchange 104, the MSC 102, and/or other elements of the communications system 100 may communicate using a signal control protocol, such as a signaling system number 7 (SS7) protocol. The SS7 protocol or similar protocols are used in publicly switched networks for establishing connections between switches, performing out-of-band signaling in support of the call-establishment, billing, routing, and implementing information-exchange functions of a publicly switched network or the wired network 118. The local exchange 104 may be owned and operated by a local exchange carrier that provides standard telephone service to any number of users. In one embodiment, the local exchange 104 may be a class 5 switch that is part of the network systems of the local carrier. The local exchange 104 may include or may be connected to the voicemail system 106. However, the local exchange 104 may also be a Digital Subscriber Line Access Multiplexer (DSLAM), Internet Protocol (IP) gateway, base station, or any other suitable network access point.

The local exchange 104 may be a wire-line switch or public exchange using time domain multiplexing to provide telecommunications services to a particular subscriber or groups of subscribers. The local exchange 104 may be located at a local telephone company's central office, or at a business location serving as a private branch exchange. The local exchange 104 may provide dial-tone, calling features, and additional digital and data services to subscribers, such as home telephone 122. The local exchange 104 may also enable VoIP communication of the home telephones 116 and 118 through a data network. VoIP works by sending voice information in digital form, such as packets, rather than using the traditional circuit-committed protocols of the publicly switched network. The local exchange 104 may be or include a feature server, a call control agent, or an IP gateway for implementing VoIP communications. The local exchange 104 may similarly track calls between a user and an advertiser for determining the efficacy of communicated advertisements.

The communications system 100 may further include any number of hardware and software elements that may not be shown in the example of FIG. 1. For example, in order to facilitate VoIP communications, the communications system and the MSC 102 and local exchange 104 in particular, may include additional application servers, media servers, service brokers, call agents, edge routers, gateways (signaling, trunking, access, sub, etc.), IP network service providers, adapters, exchanges, switches, users, and networks. The voicemail system 108 is similar to the voicemail system 106 except that it is equipped to handle voicemail for landline customers rather than wireless customers. The local exchange 104 or other components of a wire line network, such as a data, PSTN, VoIP, or other wired network may implement the features and perform the methods herein described.

The MSC 102 and the local exchange 104 may include an authentication space. The authentication space may be a partition, module, or other storage or memory of the server designated by the communications service provider. The authentication space may validate that a user or device, such as client 126, is allowed to authorize the MSC 102, local exchange 104, or corresponding voicemail systems 106 and 108 to set preferences, implement changes, review information, or perform other updates. For example, a user may first be required to provide a secure identifier, such as a user name, password, or other authentication code or hardware interface, to verify the user is authorized to make changes within the authentication space.

The authentication information may be used to create a secure connection between the client and the MSC 102 or the local exchange 104. The secure connection may be a virtual private network tunnel, an encrypted connection, firewall, or other form of secured communications link. The MSC 102 and local exchange 104 may use any number of gateways, proxies, applications, or interfaces for allowing the client 126 to communicate with the MSC 102 and local exchange 104 through the wired network 118. Alternatively, the client 126 may use a wireless network or other network to access the MSC 102 and local exchange 104. The MSC 102 and local exchange 104 may use a host client application for communicating with numerous clients.

The home 120 is an example of a dwelling, residence, or location of a person or group that may utilize any number of communications services. The home 120 is shown as a residence in the illustrated example, however, the home 120 may also be an office, business, or other structure wired or otherwise suitably equipped to provide telephone, data, and other communication services to one or more customers. In one embodiment, the home 120 is equipped with multiple communication devices, including home telephone 122 and client 126. The home telephone 122 may be standard devices that provide dialing and voice conversation capabilities. Home telephone 122 may be integrated in any number of other devices or may be used in different forms. For example, the home telephone 122 may be part of a refrigerator or intercom system. In another embodiment, the home telephone 122 may be integrated with a personal computer or display device, such as client 126 or television 124.

The communications services accessible from the home telephones 122 may include standard telephone service or VoIP telephone service. The home telephones 122 may be VoIP telephones or may be standard telephones that include a modem and/or VoIP adapters for enabling VoIP communications.

The client 126 may be a personal computer for performing and executing programs and instructions and accessing the wired network 118. However, the client 126 may be any computing devices suitable for communicating with the wired network 118 through a network connection. The wired network 118 may be a fiber optic, cable, or telephone network or other wired network suitable for communication over a hard wired connection with the client 126. In one embodiment, the home 120 may include a wireless router, adapter, switch, hub, or other suitable interface that allows the client 126 to communicate with the wired network 118. Alternatively, the client 126 may communicate with the wired network 118 through a wireless connection. The MSC 102 and local exchange 104 may use a graphical user interface (GUI), such as website or program accessible from the client 126 or television 124 in order to enter and receive user input for opting-in to advertisements or requesting additional information.

In an illustrative embodiment, the user may provide user input, request additional information, opt-in, or otherwise make selections and communicate commands using devices, such as or similar to, wireless devices 112 and 114, home telephones 122, television 124, and client 126. At any time, a user may select to enable, order, initiate, configure, reconfigure or otherwise interact with an advertisement. In other embodiments, the user may utilize a remote control for the television 124 or a Bluetooth device to provide user input.

The television 124 may receive a signal through one or more of a cable, fiber optic, DSL, satellite, or other network connection. The signal may be a traditional analog, digital, or internet protocol television (IPTV) signal. In one embodiment, the home 120 may be equipped with a satellite or other communications equipment, not specifically described herein. The television 124 may also be provided a signal through one or more intermediary devices, such as a digital video player, digital video receiver, satellite receiver, or other form of set-top box.

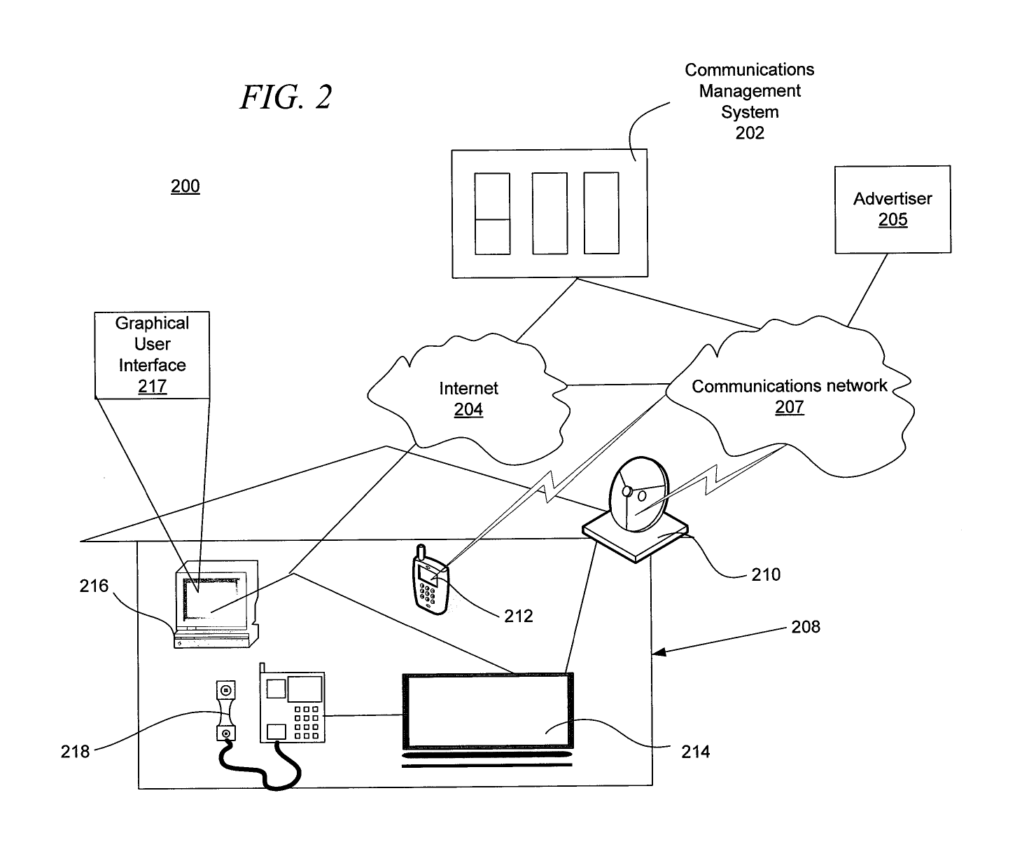

FIG. 2 is a pictorial representation of a communications environment enabling advertising in accordance with an illustrative embodiment. The communication environment 200 is a particular implementation of aspects of the communication system 100 of FIG. 1. In one embodiment, the communications environment may include a communications management system 202, Internet 204, advertiser 205, communications network 206, and home 208. The home 208 may further include a satellite 210, cell phone 212, television 214, client 216, graphical user interface 217, and telephone 218.

The communications management system 202 is the servers, switches, exchanges, intelligent devices and other elements that operate to make and receive calls, as well as send data communications to the user in the home 208. In particular, the communications management system 202 may be operated by one or more communications service providers. The communications service provider may communicate advertisements to the user through any number of end-devices, including for example, the cell phone 212, the television 214, the telephone 218 and the client 216. The communication service provider may also utilize terrestrial or satellite radios, wireless services, or other data connections to communicate advertisements. The communications management system 202 under the operation of the communications service provider identifies calls between the telephones of the user which may include telephone 218 and cell phone 212 to the advertiser 205. The calls to the advertiser 205 may be to any number of phone numbers, devices, IP addresses, lines, user names or other applicable communications elements. The communications service provider may send the advertisements to the user through any number of mediums, including television, radio, satellite, data or other forms of communications services. Alternatively, the advertiser 205 may contract with any number of television, media, or any other communications providers to transmit advertisements to the user.

In one embodiment, the communications service provider may transmit a television signal through the communications network 207 and satellite 210. The satellite 210 may transmit applicable advertisements and other media for display to the television 214. The television may allow a user to view advertisements as they are streamed or displayed to the user. In one embodiment, the satellite 210 may receive a signal that is configured by a set-top box or digital video recorder for display by the television 214. The user may view the advertisement on the television 214 at any time.

In one embodiment, the advertisement may include an icon, button, or other selection element or indicator that the user may select in order to receive additional information. For example, the user may use a remote control of the television 214 to select an icon indicating that the user would like to receive additional information from the advertiser 205. The additional information may be sent to the television 214, the cell phone 212, the telephone 218 or the client 216. The additional information may be sent in the form of a discrete text message, email message, chat conversation, hyperlink, graphic, chat session, video, picture, or other applicable data or information. By selecting active links or information in the message, the user may be directly connected through the applicable communications device to the advertiser 205 for voice communications. In one embodiment, by requesting additional information, a voice call may be initiated by the user.

The additional information may include contact information, such as phone numbers, IP addresses, directions, email addresses, usernames, chat names, 1-800 numbers, or other applicable contact information. The additional information may also include advertising related information such as, coupons, discounts, rebates, price, description, web links or other images, textual information or data that allows the user to determine whether to purchase or otherwise research details of the advertisement. Revenue for advertising may be generated based on calls received by the advertiser 205 or computer clicks to a relevant hyperlink or web access element.

In one embodiment, the user may access the graphical user interface to view a log of additional information requested by the user. The communications management system 202 may provide a web portal accessible by the client 216 through the Internet 204. As a result, the user may access the additional advertisement information using an advertising log or other screening function available through the portal.

In another embodiment, an advertisement displayed to the user through any of the devices shown in the home 208 may be utilized to directly contact the advertiser 205 through the Internet 204 and/or through the communications network 207. The communications management system 202 may track when and how advertisements are displayed to the user. In particular, the communications management system 202 may log advertisements or requests for additional information when displayed to the user or requested by the user. For example, time stamps and time periods may be used to determine when an advertisement was played to the user, when additional initial or additional information was requested, and how much time passed before the user contacted the advertiser. This information or other criteria, rules, or logic may be utilized to determine if the advertiser is billed for a subsequent call from the user to the advertiser 205. Correspondingly, subsequent calls from the user through the cell phone 212, television 214, client 216 or telephone 218 may be tracked for billing the advertiser 205 for the calls. As a result, the advertiser 205 may be more effectively billed for advertisements displayed or transmitted to the user by the communications management system 202. Additionally, the advertiser 205 may receive additional analysis, data, and statistics from the communications management system 202 regarding the most effective advertising method times, demographics, and other applicable advertising information.

The user may receive fulfillment services for the selected products, services, or information at any time based on a response to the initial advertisement, additional information, or opt-in request. For example, a user may select to receive additional information regarding a pizza delivery special and then make a call to order various pizzas. The call from the user to the pizza store triggers an advertisement fee billed by the communications service provider to the advertiser.

In another embodiment, the user may be listening to a standard or satellite radio within the communication environment 200. A list of radio stations may be loaded on the cell phone 212, television 214, client 216, or telephone 218. When a user is interested in a particular advertisement, the user may select the name or call sign of the applicable radio station to receive additional information or view a graphic or textual representation of the advertisement.

In another embodiment, the user may view an advertisement through a print or outdoor advertisement. If the user is interested in learning more about the product/service or other message being advertised, the user may send a text, short message service (SMS), email, or other form of message to the advertiser. The user may be required to implicitly or explicitly specify a code identifying the advertisement. For example, a dedicated text message or phone number may specify which billboard advertisement was viewed by the user and the applicable service or product the user is interested in. The advertiser may be billed for advertising hits based on subsequent calls between the user and the advertiser, based on the initial message, or both. Alternatively, the specific advertisement viewed by the user may be ascertained by determining the exact or approximate location of the user when additional information is requested, a call is made, and opt-in request is generated, or based on other user feedback. The specific advertisement may be determined based on a users location during the day. In one embodiment, the user may be required to provide an advertisement identifier as part of a message or communication.

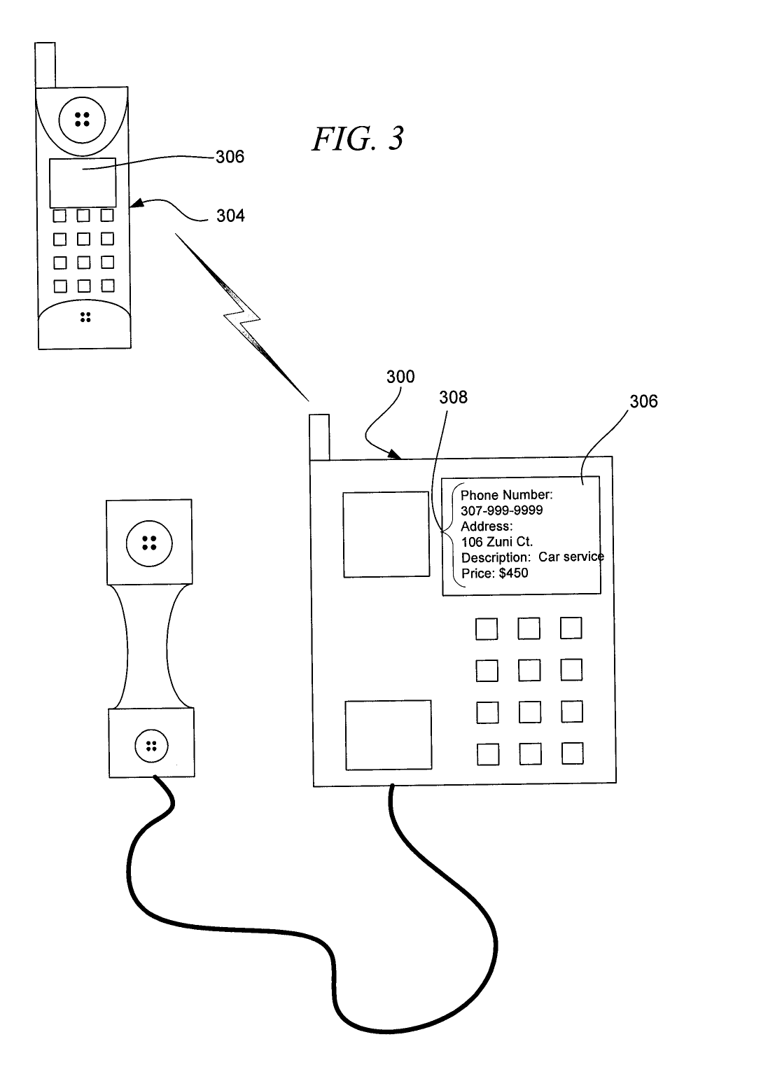

FIG. 3 is a pictorial representation of a telephone in accordance with an illustrative embodiment. The telephone 300 is an illustrative embodiment of a VoIP telephone. The telephone 300 may also be equipped for POTS communications or for wireless communications. The telephone 300 may include handset 304 and display 306. The display 306 may display information 308, data, and advertisements.

In one embodiment, an advertisement may be displayed directly to the telephone 300. Alternatively, the user may select to receive additional information using a device in communication with the telephone 300. For example, a user watching television may view an advertisement for an anti-virus software. By selecting an icon presented on the screen, additional information shown as the information 308 may be sent to the telephone 300 for subsequent use by the user. The user may also select an icon, button, indicator, provide a voice command, or otherwise enter a command to automatically call a number associated with the advertiser or to request additional details or information.

In one embodiment, by selecting the information 308, the call from the user utilizing the telephone 300 to the advertiser is tracked and the advertiser is billed by the communications service provider for each call made as a form of advertising revenue. The user may also access a web portal through the telephone 300 to view the information 308.

The handset 304 may be equipped to share a communications line or link with the telephone 300. For example, the handset 304 may be a cordless extension of the telephone 304 utilizing any number or short-range cordless frequencies. In one embodiment, the handset 304 is simply an extension of the telephone 300 in which the handset 304 and the telephone 300 communicate wirelessly to send and receive data, information, and voice communications. The handset 304 may also include the display 306 for displaying the information 308 or other information commonly displayed by a telephone or utilized in accordance with the illustrative embodiments. The handset 304 and the telephone 300 may communicate using any number of frequencies, standards, or communications protocols, usually effective over short distances throughout a user's home or business.

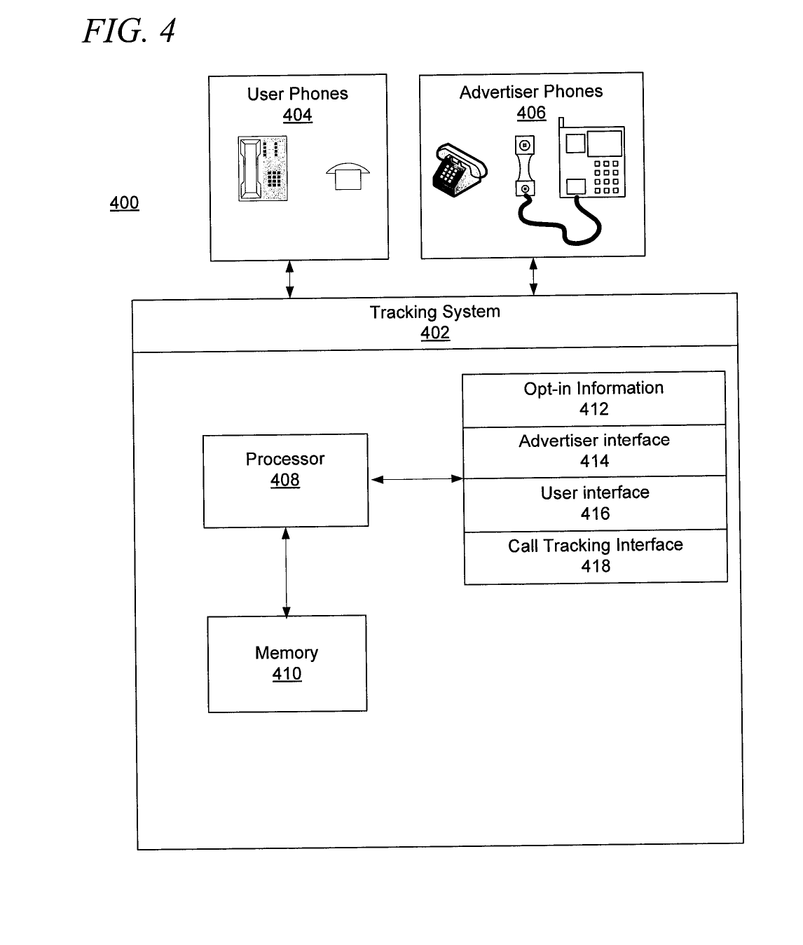

FIG. 4 is a pictorial representation of a tracking environment in accordance with an illustrative embodiment. The tracking environment 400 may include a tracking system 402, user phones 404, advertiser phones 406. The tracking system 402 may also include a processor 408, a memory 410, opt-in information 412, advertiser interface 414, user interface 416, and call tracking interface 418.

The user phones 404 are the communications devices that may be utilized by the user to communicate voice communications. The user phones 404 may be home phones, cell phones, work phones, numbers IP addresses, or other communications devices or elements utilized by the user for carrying on voice communications. The user phones 404 represents numerous users and phones associated with each user. In one embodiment, the user may be required to associate or link numbers or devices with a profile or other information in order to be categorized as the user phones 404. The advertiser phones 406 are the phones, numbers or communications devices linked with an advertiser. For example, the user phones 404 and the advertiser phones 406 may encompass voice over IP phones, talk telephones, cell phones, soft phones and other communications related elements.

In one embodiment, each advertisement and advertiser may specify any number of phone numbers that are linked with the advertiser. The revenue is tracked specifically between the user phones 404 and the advertiser phones 406 by the tracking system 402. The tracking system 402 may be a switch, server, router, exchange, or other intelligent device for both routing the calls from the user phones 404 to the advertiser phones 406 and/or tracking those calls. The tracking system 402 may include logic for determining whether the call is related to an advertisement and whether credit is to be granted to the communications service provider and/or other party transmitting the advertisement to any number of users. The tracking system 402 may include logic, circuitry, firmware, databases, memory, cards, communications ports and elements, and other hardware and software elements.

The processor 408 is circuitry or logic enabled to control execution of a set of instructions. The processor 408 may be a microprocessor, digital signal processor, central processing unit, or other device suitable for controlling an electronic device including one or more hardware and software elements, executing software, instructions, programs, and applications, converting and processing signals and information, and performing other related tasks. The processor 408 may be a single chip or integrated with other computing or communications elements of the tracking system 402.

The memory 410 is a hardware element, device, or recording media configured to store data for subsequent retrieval or access at a later time. The memory 410 may be static or dynamic memory. The memory 410 may include a hard disk, random access memory, cache, removable media drive, mass storage, or configuration suitable as storage for data, instructions, and information. In one embodiment, the memory 410 and processor 408 may be integrated. The memory may use any type of volatile or non-volatile storage techniques and mediums. The tracking system 402 may include any number of computing elements including busses, cards, interfaces, drives, boards, and other elements included in communications equipment although not specifically described herein.

The tracking system 402 may also communicate with other user devices or advertiser devices or elements. The tracking system 402 further includes the opt-in information 412, advertiser interface 414, user interface 416 and the call tracking interface 418. The user interface 416 allows the user to interact with the tracking system 402. The interactions may be performed automatically or manually based on user selections. Similarly, the advertiser interface 414 allows the advertiser phones 406 and other advertising devices to interface with the tracking system 402. In one embodiment, the tracking system 402 is controlled by a communications service provider or other third party that is not controlled by the user or the advertiser. However as described, the user and the advertiser may interface with the tracking system 402 through the user interface 416 and the advertiser interface 414, respectively.

The opt-in information 412 is the data or information that is transmitted to one or more user devices based on a user selection. For example, based on a user selecting an icon available during a television advertisement, the opt-in information 412 may send information to the user's phone, television, or to a web portal available through the tracking system 402. The opt-in information 412 may also allow a user to opt-in to receive additional information regarding categories, stores, products, or services. In one embodiment, the user may subscribe to have new sales information for a car dealership automatically sent to a page accessible by the user through the portal of the communications service provider. In addition, a list of local providers/advertisers may be included in the opt-in information.

The advertiser interface 414 and user interface 416 may be integrated with a web portal that allows one or more users and advertisers to access information and data available through the tracking system 402. In one embodiment, the advertisers may upload advertisements to be distributed by the communications service provider through the advertiser interface 414. In another embodiment, the user phones may utilize the user interface 416 to request additional information or make a selection to dial the advertiser phones 406. More specifically, a web portal may be accessible through the tracking system 402 to view opt-in information 412 specifically selected by the user. The opt-in information 412 may include additional details, including phone numbers, directions, price, description, web links or other images, textual information or data that allows the user to determine whether to purchase or otherwise research details of the advertisement. As previously described, the opt-in information 412 may send a message data stream or other information to the user phones 404 or other interconnected devices or elements.

The call tracking interface 418 tracks calls between the user phones 404 and the advertiser phones 406. In particular, the call tracking interface 418 determines when a voice connection is made between the user phone 404 and the advertiser phones 406. The call tracking interface 418 may track a balance charged to an advertiser based on calls from one or more users to the advertiser phones 406. For example, the advertiser may be charged 20¢ for each call originating from the user phones 404 which may represent one or more users.

The call tracking interface 418 may also include an advertising log that notes when advertisements were displayed to one or more users and when additional information or opt-in information 412 was requested by one or more users. As a result, the call tracking interface 418 may be able to determine the efficacy of an advertisement based on a number of users that called the advertiser phones 406 after communication or playback of an advertisement to any number of users. The call tracking interface 418 may identify any number of advertisements displayed to the users through a code or other identifier. The identifiers of advertisements may be associated with additional requests for information transmitted to the opt-in information 412. The users and the advertisers may set any number of preferences detailing how advertisements are presented or utilized by the user. For example, the user may select to automatically dial the advertiser phones 406 from a user phone by selecting a link available through the web portal.

In one embodiment, the identifier and a log may be utilized to determine and statistically measure the effectiveness of advertisements with regard to call volume to the advertiser prompted by one or more advertisements. For example, a particular series of car commercials may encourage approximately one hundred calls within a target area every time one of the commercials is played over a cable or satellite radio channel. The statistics, tracking information, and projected advertising revenues may be sent to the advertiser and communications service provider hourly, daily, weekly, or as specified by the applicable parties. The tracking system 402 may utilize time stamps to determine when an advertisement was placed, additional information requested, an opt-in request generated, and fulfillment services, such as an order or request for services or products is made. The time stamp may be utilized in conjunction with an advertisement indicator to determine when and how the user responded in any manner to the advertisement. Additionally, the communication service provider and advertiser may have contractually agreed that the calls are to be within specified time period to trigger the agreed upon advertising fees.

In another embodiment, the tracking system 402 may also be applicable to radio transmissions. The advertisements played to one or more users through any number of home, call, or other mobile radios may be similarly tracked and calls between the user phones 404 and the advertiser phones 406 may also be utilized for determining advertising revenues to be charged to one or more advertisers.

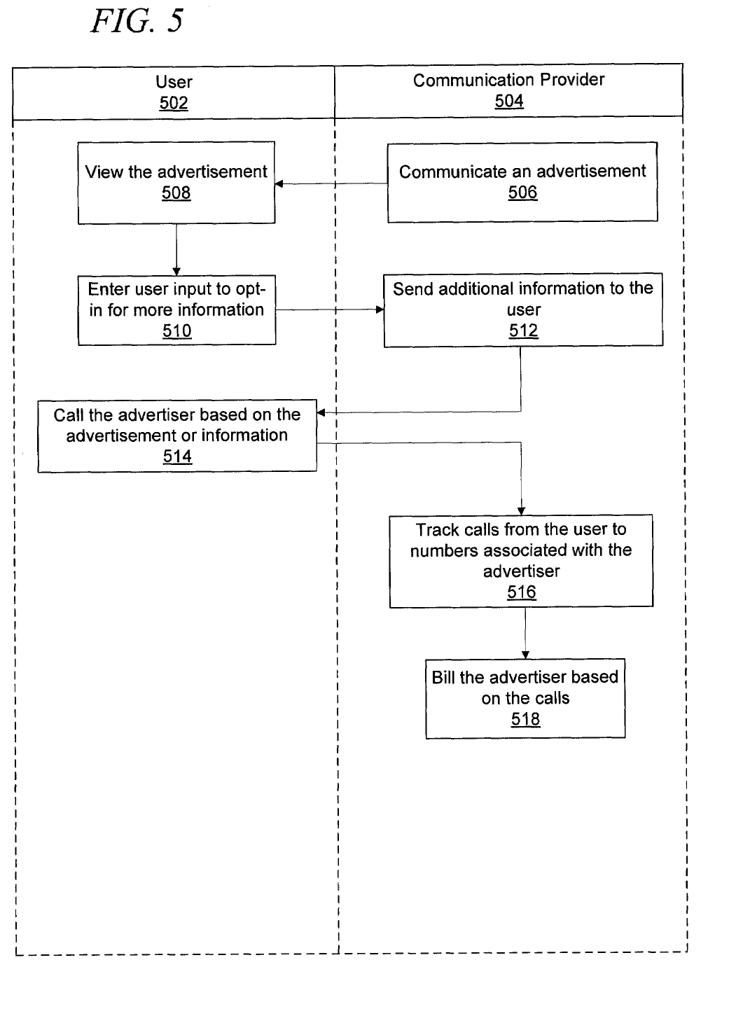

FIG. 5 is a flowchart of a process for tracking advertisements in accordance with an illustrative embodiment. The process of FIG. 5 may be implemented by a user 502 and a communications provider 504. The user 502 may be utilizing a television, radio or telephonic device to receive the advertisements, make user selections and provide other feedback as described in FIG. 5. The communications provider 504 may be a communications management system server or any number of hardware and software elements utilized by the communications provider 504. The process of FIG. 5 may begin with the communications provider communicating an advertisement (step 506). As described, the advertisement may be a visual, audio or other form of advertisement of a advertiser or local provider. The advertiser may provide goods, services or other products to any number of users. The communication provider 504 and advertiser may have a contract specifying how and when advertisements are displayed in addition to other distribution terms.

Next, the user 502 views the advertisement (step 508). The advertisement may be displayed on a television, radio or other telephonic device, such as a cell phone, VoIP telephone, or POTS telephone. The advertisement may be displayed as part of a cable, DSL, Internet Protocol television (IPTV), Internet, satellite or terrestrial radio, or other form of media communications. The advertisement of step 508 may further include an icon, link, or other indicator that allows the user to select to receive more information.

The user 502 enters user input to opt in for more information (step 510). The user input or user selection may be the selection of an icon or other indicator. By allowing the user to opt in, individual users do not feel like they are coerced or otherwise influenced to receive advertising information they are not interested in. Additionally, the user may feel less pressure to make an immediate decision and may instead review the advertising information at a later time based on a personal timeline or schedule. The additional information may include contact information for the advertiser, additional product or service information, links, hyperlinks or other advertising materials, such as brochures, electronic files, documentation or other information and data.

Next, the information provider 504 sends the additional information to the user (step 512). The information may be sent from the communications provider 504 to the user 502 through any number of designated communications means. In one embodiment, the user 502 may specify an e-mail address, phone number, IP address, user name, account number or other information for receiving additional information as selected by the user 502. The additional information provided by the communications provider 504 on behalf of the advertiser may provide the additional information needed by the user 502 to determine whether to purchase or further investigate the products and services offered by the advertiser. The additional information may also include information such as a map, driving directions, coupon, promotional code, or other similar information that may be useful or required for fulfilling a request for a product or service.

Next, the user 502 calls the advertiser based on the advertisement or additional information (step 514). The call may be made based on the manual selection by the user. Alternatively, the call may be automatically initiated in response to the user selecting an icon or other indicator displayed during the advertisement or when the additional information is received. In one embodiment, the number, IP address, or other information utilized to initiate the call in step 514 may be linked with a particular advertisement. For example, a group of 1-800 numbers may be associated with a series of truck commercials commissioned by the advertiser running only in the month of May. In addition, numerous phone numbers or other communications designators may be rotated in and out of usage in order to more easily track advertising effectiveness. As a result, it is easy to determine that calls to the advertiser are generated based on the advertisement because of the number of calls by consumers to the designated 1-800 numbers or other dedicated lines of communication.

The communications provider 504 tracks calls from the user 502 to the numbers associated with the advertiser. The calls are tracked in step 516 based on the contractual agreement, permissions or authorizations from the user 502 to the communications provider 504. The user 502 may be required to explicitly authorize the tracking of the calls as described herein. In another embodiment, the user may be required to enter a code or identifier related to the advertisement. The code may be a word, number, or other combination of alphanumeric elements that identifies the advertisement viewed by the user. This code may be linked to a sale or promotion and may otherwise indicate that the user is calling based on the advertisement that the user heard, viewed, or otherwise received. The code or dedicated phone numbers may be utilized to ensure that the advertiser is not overcharged by the communications service provider based on random calls from one or more users to the advertiser.

In one embodiment, the calls may be easily tracked from a telephonic device of the user 502 because the communications provider 504 provides any number of local services which may include VoIP, POTS, software phones, wireless services, and any number of other communications services. The user 502 and the advertiser may utilize any number of telephone numbers or devices to send and receive communications. The communications provider 504 may track calls from any device or number associated with the user 502 to any number or device associated with the advertiser. The communications provider 504 bills the advertiser based on calls received from a user and has requested more information (step 518).

In another embodiment, the advertiser may only be billed for a call from the user 502 if the user 502 has previously opted in or requested more information. Alternatively, the advertiser may be billed only if the user 502 makes a call within a designated time period. For example, an agreement between the advertiser and the communications service provider may specify that only calls within a week period of the user 502 requesting more information may be billed to the advertiser. Any number of time periods or other criteria may be utilized to determine whether the advertiser is to be charged by the communications provider 504 for the communicated advertisements. The process of FIG. 5 provides a more accurate way of tracking advertising effectiveness and revenue generation based on the advertisements.

In another embodiment, the communications provider 504 may also track usage of links provided to the user 502 to navigate to a website of the advertiser. As a result, even if the user 502 does not call the advertiser, the effectiveness of the advertisements may be determined using traditional “clicks” or network based access to advertising materials. The illustrative embodiments, may allow local or national advertisements to be more effectively tracked at a local level. For example, nationwide advertisements for a truck company may be broadcast with the resulting sales call tracked by the local communications service provider in order to effectively bill the advertiser. Traditional air time based expenses may be combined with click-based and call-based advertising.

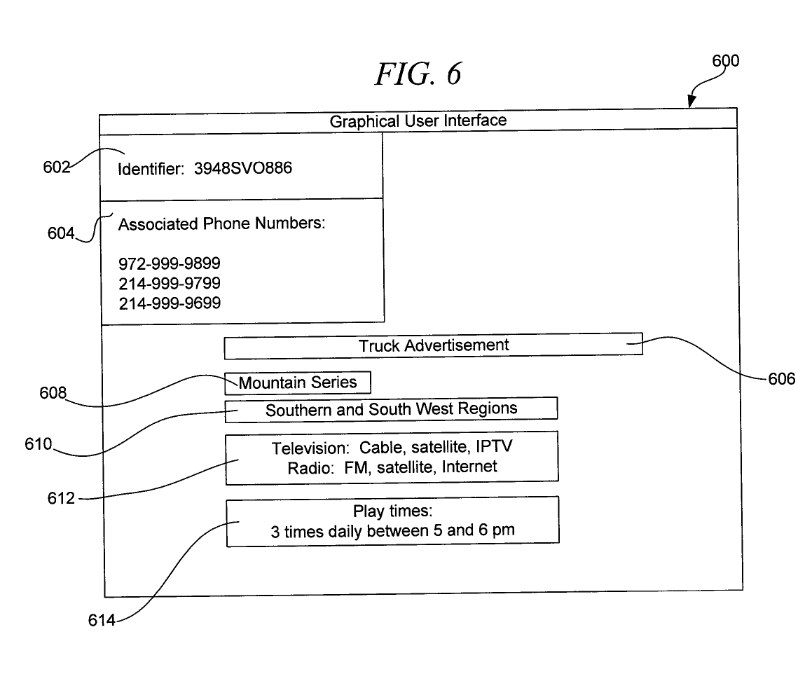

FIG. 6 is a pictorial representation of a graphical user interface in accordance with an illustrative embodiment. The graphical user interface 600 may include various sections, icons, indicators, selections, buttons, or other elements for displaying information and receiving user input. In one embodiment, the graphical user interface 600 may include an identifier 602, associated phone numbers 604, advertisement 606, description 608, location 610, transmission type 612, and play times 614.

The graphical user interface 600 may be displayed on a television, VoIP phone, wireless device, or other electronic device. In one embodiment, the graphical user interface 600 may be utilized with a touch screen in order to interactively display and receive information and data from the user.

The identifier 602 is information or data that identifies an advertisement. The identifier 602 may also identify a series of advertisements. The identifier 602 may be a code, word, or other information suitable for identifying a particular advertisement. In one embodiment, the identifier may be part of or the entire phone number.

The associated phone numbers 604 are one or more phone numbers, IP addresses, email addresses, or other contact information that allows a user to contact an advertiser with regard to the advertisement 606. Revenue for user actions may be based on calls from the user to the associated phone numbers 604. The associated phone numbers 604 may be the numbers included in the advertisement or sent to the user based on a request for additional information. In particular, a call from the user to the advertiser denoted by the associated phone numbers 604 indicates that the user has viewed the advertisement and is taking some additional steps based on that information. In one example, the advertiser may be charged a twenty five cent fee for each phone call or other communication that occurs based on the user viewing the advertisement 606. In another example, the user may select a web link or text message to the advertiser in order to incur an additional revenue expense.

The advertisement 606 is the name or identifying information about the particular advertisement. The graphical user interface 600 may display titles or information for any number of advertisements. The graphical user interface 600 only illustrates advertisement 606 for purposes of simplicity. The description 608 may further identify the product, services, or other information offered by the advertisement 606. In some cases, advertisers may advertise hundreds or thousands of different products at a time and may need more information to properly identify the type of advertisement.

The location 610 may specify a region, city, town, metropolitan area, or other information indicating where the advertisement is being communicated. The location 610 may also use zip codes, city names, or other information suitable for identifying where the advertisements are communicated or where a user may take an action based on the advertisement. For example, even though an advertising event is national, requests for additional information may be for local providers or advertisers.

The transmission type 612 is a list of the transmissions mediums utilized to broadcast the advertisement to one or more users. In the embodiment illustrated by the graphical user interface 600, the advertisement 606 may be displayed to users through television including cable, satellite, and IPTV or radio including FM, satellite, or Internet. The transmission type 612 may describe any type of general and specific advertisement transmission information.

The play times 614 is information regarding when the advertisement 606 is played to one or more users. The play times 614 may generally describe times when the advertisement 606 has or will be played. Alternatively, the play times 614 may be an exact schedule and/or log detailing the exact time the advertisement 606 is scheduled to or has been played.

The illustrative embodiments allow a local communications service provider to leverage services and relationships of the local community to provide more effective call and traditional click based advertising. In addition, national and local advertisements may more effectively be targeted based on results that are more easily determined.

The previous detailed description is of a small number of embodiments for implementing the invention and is not intended to be limiting in scope. The following claims set forth a number of the embodiments of the invention disclosed with greater particularity.

What is claimed:

1. A method for tracking calls based on advertising, the method comprising:
communicating an advertisement to a user through a communications network;
determining that a call connection is made between the user and an one or more numbers associated with the advertiser; and
billing the advertiser in response to the determined call connection.

2. The method according to claim 1, further comprising:
receiving a user selection to receive additional information regarding the advertisement, wherein the advertiser is billed based on the number of calls received by the advertiser from the one or more users that have requested the additional information

3. The method according to claim 1, wherein the additional information is received from a server, wherein the additional information provides contact information and web links for the advertiser and information regarding a subject of the advertisement.

4. The method according to claim 1, further comprising:
recording a time stamp indicating the time and date the advertisement is communicated, the user selection is received, and the call is made.

5. The method according to claim 1, wherein the advertiser and the user receive telecommunication services through a single communications service provider, where in the communications service provider performs the communicating, determining, and billing.

6. The method according to claim 1, further comprising:
displaying an indicator to a display as part of the advertisement, wherein the user selects the indicator to make the user selection; and
receiving an identifier associated with the advertisement during the call for billing the advertiser for a user response to the advertisement.

7. The method according to claim 1, wherein the additional information is accessible by the user through a web portal.

8. The method according to claim 7, further comprising:
automatically dialing the advertiser based on the user selection.

9. The method according to claim 1, wherein the telephonic device is any of a cellular phone, voice over internet protocol phone, or a plain old telephone service telephone.

10. The method according to claim 1, further comprising:
billing the advertiser for the call from any number of phone numbers associated with the user.

11. A system for tracking calls generated based on advertisements, the system comprising:
a communications network;
one or more user connections communicating with the communications network;
one or more advertiser connections communicating with the communications network; and
a server connected to the communications network configured to track calls from the one or more user connections to the one or more advertiser connections, the server comprising:
an advertiser interface configured to transmit advertisements to users through the one or more user connections; and
a call tracking interface configured to identify calls from the one or more user connections to phone numbers dedicated for use with one of the advertisements, the interface operable to initiate billing of at least one advertiser based on a number of calls received by the advertiser through the phone numbers as a result of the one or more users calling the phone numbers.

12. The system according to claim 11, wherein the communications network, the one or more user connections, the one or more advertiser connections, and the server are operated by a local communications service provider.

13. The system according to claim 11, wherein the advertiser is billed in response to the calls being placed within a time period of the users receiving the advertisement.

14. The system according to claim 11, wherein the users enter an identifier associated with the identifier to complete a call to the advertiser.

15. The system according to claim 13, wherein a time stamp is taken when the advertiser is transmitted to the user, when the user selects to receive the additional information, and in response to the calls to determine that the time period is satisfied for billing the advertiser.

16. An advertising server comprising:
a processor for executing a set of instructions; and
a memory for storing the set of instructions, wherein the set of instructions are configured to communicate an advertisement to a user through a communications network, receive a user selection to receive additional information regarding the advertisement, determine whether a call connection is made between the user and an one or more numbers associated with the advertiser, track a number of calls from one or more users to one or more numbers associated with the advertiser, and bill the advertiser based on the number of calls received by the advertiser from the one or more users that have requested the additional information.

17. The advertising server according to claim 16, wherein the advertising server and the communications network are operated by a communications service provider.

18. The advertising server according to claim 16, wherein the one or more numbers is dedicated for receiving calls in association with the advertisement.

19. The advertising server according to claim 16, wherein the set of instructions are configured to request an identifier associated with the advertisement to bill the advertiser based on the number of calls.

20. The advertising server according to claim 16, wherein a time stamp is taken when the advertisement is transmitted to the user, when the user selects to receive the additional information, and in response to the call to determine that the call is made within a time period for billing the advertiser.
